(19) United States
(12) Patent Application Publication
(10) Pub. No.: US 2012/0140456 A1
(43) Pub. Date: Jun. 7, 2012

(54) LASER DAZING BATON SHAPED OPTICAL DISTRACTOR AND SEARCHLIGHT

(75) Inventors: Robert D. Battis, Mercerville, NJ (US); Wayne Armstrong, Placitas, NM (US)

(73) Assignee: Laser Energetics Inc., Mercerville, NJ (US)

(21) Appl. No.: 13/375,635

(22) PCT Filed: Jun. 1, 2010
(86) PCT No.: PCT/US10/36932

§ 371 Date: Jan. 4, 2012

Related U.S. Application Data
(63) Continuation of application No. 61/237,371, filed on Aug. 27, 2009.
Application No. 61/237,371 is a continuation of application No. 61/218,675, filed on Jun. 19, 2009.
Application No. 61/218,675 is a continuation of application No. 61/182,824, filed on Jun. 1, 2009.
Application No. 61/182,824 is a continuation of application No. 61/218,682, filed on Jun. 19, 2009.
Application No. 61/218,682 is a continuation of application No. 61/182,823, filed on Jun. 1, 2009.

(51) Int. Cl. F21L 4/08; F21L 4/02; F21L 13/00

(52) U.S. Cl. 362/183; 362/192; 362/184

(57) ABSTRACT

Provided is a laser dazing apparatus shaped as a baton having a cylindrical encasement including a forward end housing a focusing range adjustment fixture and a laser aperture. The encasement also includes a finned heat sink (106), a set of finger detents (102), a plurality of indicators (109), operating buttons (110) and switches (111) and a rear push button trigger (104) controlling divergence. The apparatus also includes at least one battery (240) for electrical power, and a plurality of control circuits (210, 215) controlling the laser generation device (220), battery (240), indicators (109) and switches (112). The apparatus also includes a focus range adjuster.

### CROSS REFERENCE TO RELATED APPLICATIONS

This application is related to and claims priority from U.S. Provisional Patent Applications No. 61/182,824 filed on Jun. 1, 2009, by Robert Battis, et al. titled “Dazer-Laser Guardian,” No. 61/218,682 filed on Jun. 19, 2009, by Robert Battis, et al. titled “Dazer-Laser Guardian,” and No. 61/273,371 filed on Aug. 27, 2009, by Robert Battis, et al. titled “Dazer Laser Mean Beam Improvement.” This application is also related to U.S. Provisional Patent Applications No. 61/182,823 filed on Jun. 1, 2009, by Robert Battis, et al. titled “Dazer-Laser Defender” and No. 61/218,675 filed on Jun. 19, 2009, by Robert Battis, et al. titled “Dazer-Laser Defender.” These applications are incorporated herein by reference in their entirety.

### FIELD OF THE INVENTION

This invention generally relates to a laser search and dazing devices, and more particularly to a device for optically distracting or dazing a person.

### BACKGROUND OF THE INVENTION

Dazing refers to the temporary, safe and reversible physiological effect that a laser beam of radiation has on a subject person's eyes and brain after the person has received a short dose of laser radiation. Dazing usually results in momentary flash blindness lasting a few seconds, followed by a feeling of disorientation, and may also result in a mild headache and motion sickness, which may last several hours. These dazing effects are completely reversible, even after repeated dazings. There are several useful articles describing the physiological background for the effects of a dazing laser on a subject person. One such online article is entitled “Temporal Resolution” and is available at http://webvision.med.utah.edu/temporal.html. Additional references include: “Flicker an Intermittent Stimulation”, Vision and Visual Perception, Graham, C. H., (ed), New York: John Wiley and Sons, Inc., 1965, and “Research into the Dynamic Nature of the Human Fovea: Cortex Systems with Intermittent and Modulated Light, Phase Shift in Brightness and Delay in Color Perception,” De Lange, J Opt Soc Am 48: 784-789 (1958).

Use of lasers for sighting, searching and dazing is not new, for example, U.S. Pat. No. 7,584,569 to a “Target illuminating assembly having integrated magazine tube and barrel clamp with laser sight,” by Kallio, et al., (hereinafter, the '569 patent) describes a laser sighting module for use on the barrel of a weapon, wherein the target illuminator can be a solid-state light emitting device. The '569 patent mentions use of the laser sighting device for dazing, although the device lacks several important features of the present invention.

The laser sighting device of the '569 patent, as well as other conventional laser searching devices, are not easily usable as a dazer device for several reasons. Dazing requires illumination of the subject person's eyes. While a searching device might use a tightly focused laser beam for distance, the fluence or area illuminated would be small, making it difficult to illuminate the subject person's eyes. Yet, use of a divergent laser would dissipate the beam over long distances, thereby mitigating any dazing effect. Thus, there is a need for a laser dazing device which allows for fast toggling between a laser search mode and a laser dazing mode.

Also, the dazing effect of prior dazing lasers is limited by the power of the laser beam used. Use of a more powerful laser beam to increase the dazing effect necessarily increases the “minimum safe range,” or distance at which the laser beam is considered safe and its effects reversible. Thus, use of a more complex laser beam delivering enhanced dazing effects with less power and a shorter minimum safe distance is also desirable.

Moreover, prior laser dazing devices provided a fixed focus, which resulted in a fixed range of dazing usefulness. It is thus also desirable to provide for changing the range and focus of a laser dazer device as needed for a particular application.

### SUMMARY OF THE INVENTION

An aspect of the present invention provides a baton-shaped laser dazing apparatus including an elongated cylindrical encasement having a forward end and a rear end. The encasement includes a control cylinder at the forward end housing a focusing range adjustment fixture and a laser aperture, as well as a finned heat sink, a set of circumferential finger detents, a plurality of indicators, operating buttons and switches, and a rear push button trigger. The cylindrical encasement provides an enclosure for a laser generator, a least one battery for electrical power, and a plurality of control circuits in communication with the laser generator, battery, indicators, buttons and switches. In use, the trigger causes the control circuits to control the laser generator to generate electromagnetic output.

### BRIEF DESCRIPTION OF THE DRAWINGS

FIG. 1 is a depiction of a baton shaped laser dazer, in accordance with an embodiment of the present invention;

FIG. 2 depicts a partially disassembled baton shaped laser dazer, in accordance with an embodiment of the present invention;

FIG. 3 depicts another view of a partially disassembled baton shaped laser dazer, in accordance with an embodiment of the present invention;

FIG. 4 is a machine state diagram for a laser dazer, in accordance with an embodiment of the present invention;

FIG. 5 is a schematic functional flow diagram for a laser dazer, in accordance with an embodiment of the present invention;

FIG. 6 is a schematic functional flow diagram for variable range and focus in a laser dazer, in accordance with an embodiment of the present invention;

FIG. 7 is a schematic diagram of MEAN Beam generation, in accordance with an embodiment of the present invention;

FIG. 8A illustrates generation of a MEAN Beam, in accordance with an embodiment of the present invention;

FIG. 8B further illustrates generation of the MEAN Beam as in FIG. 13A;

FIG. 9 is a schematic diagram illustrating a typical prior art fixed focus system;

FIG. 10 is a graphical illustration of factors encountered in a system according to FIG. 9;

FIG. 11 is a schematic diagram illustrating variable range and focus of a laser dazer, in accordance with an embodiment of the present invention;

FIG. 12 is a graphical illustration of advantageous factors of a system according to FIG. 11;

FIG. 13 depicts a fiber optic adapter, in accordance with an embodiment of the present invention; and,

FIG. 14 depicts a wand diffuser adapter, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

An embodiment of the present invention advantageously provides for a laser dazing device which allows for fast toggling between a laser search mode and a laser dazing mode.

An embodiment of the present invention also provides for use of a complex laser beam delivering enhanced dazing effects with less power and a shorter minimum safe distance is also desirable.

Another advantageous aspect of the present invention is allowing for changing the range and focus of a laser dazer device as needed for a particular application.

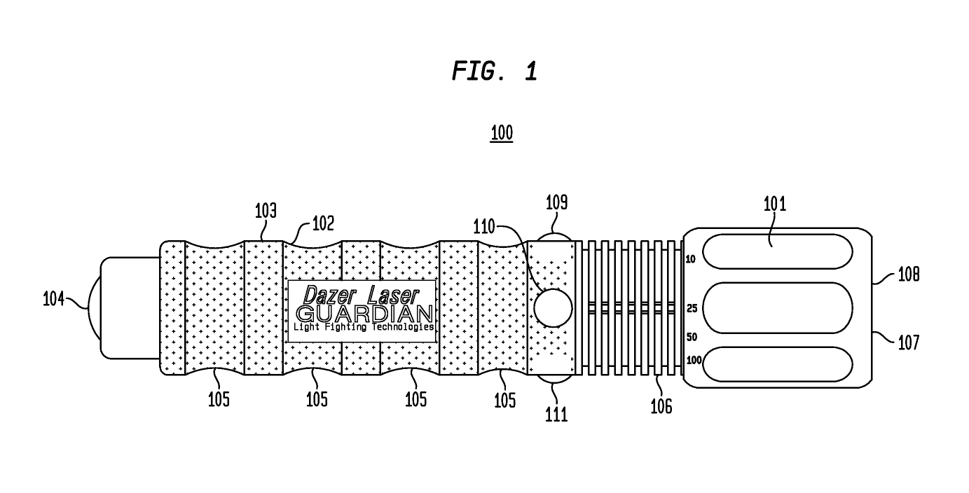

FIG. 1 depicts a external views of exemplary dual mode baton, cylinder or flashlight shaped dazer laser apparatus 100 (hereinafter referred to as “dazer laser apparatus,” or simply “apparatus”).

The apparatus 100 features a laser or laser diode search mode and a laser or laser diode dazing mode, with both modes emitting light at a preferred wavelength, for example 532 nm, or alternatively with the search mode emitting radiation at a wavelength different than dazing mode.

The dazing mode provides the user an ability to daze a subject person, whereas search mode allows the user to perform a visual search for a threat subject, much like using a flashlight, except with a highly directional and focused beam. The power level used in the search mode is significantly reduced from the dazing mode.

In exemplary embodiments of the present invention, the apparatus 100 includes a control cylinder 101 coupled to an optical train, which provides for focusing, either manually or through an automatic control loop tied to a range finder (not depicted). The adjustment range is indicated on a dial 109, as is the corresponding ANSI safe range. In an embodiment of the invention, an option for providing range via a readout device tied to the adjustment mechanism through appropriate electronics is included. Focusing may be accomplished manually or may be motorized, as described in further detail below.

The search mode features a continuous wave (hereinafter “CW”) beam of visible light, and the dazing mode features a MEAN beam, as described in detail herein below, tailored for optimum dazing effectiveness for the prevailing laser power and device operational range. Both modes emit radiation from the apparatus' front aperture 107.

In an embodiment of the invention, the approximate dimensions of the apparatus 100 are 6 inches in length with a 1.3 inch diameter. The apparatus 100 is battery operated and features a focus adjustment which sizes the beam for various target ranges from 1 meter to 25, 100, 300, or more meters, depending on the specific model of the apparatus 100. In an embodiment of the invention, range adjustment or beam focusing is accomplished by manually turning the front section 101.

The apparatus also includes finned heat sink 106, circumferential finger detents 105 and several operating buttons 109, 110, 111, etc. The rear push button is a trigger 104 that activates the dazing mode. The dual action front button 110 activates either the search mode or the dazing mode. The two side buttons 110 function as security code entry buttons, and one is alternatively used to control a critical operational parameter of the MEAN Beam, as described below. This button sets the MEAN Beam parameters for night or day operation. All push buttons are momentary and interface directly with control circuits.

The apparatus 100 encloses a laser generator, a least one battery for electrical power, and control circuits, also called the “micro-control unit,” or “MCU,” and electronics for controlling, energizing, and monitoring these and other components as needed.

The apparatus 100 operates from either one-time use lithium batteries or rechargeable batteries, which are easily replaced and accessible through the threaded end cap 104.

A vibrator device, built into the handle, is used to signal the user for key events, such as security code entry, low battery or high temperature.

To prevent use of the apparatus by unauthorized persons, the a security code is used which is designed to time-out and thereby prevent the apparatus from working. The security code may be reinstated quickly in the field by an authorized person equipped with the code sequence. The code may be re-instated manually by pressing buttons on the device, or, alternatively, the code may be re-instated using a separate ancillary piece of equipment. In an embodiment of the invention the security code feature may be disabled.

In an embodiment of the invention, the laser is passively cooled by conduction and convection through the heat sink 106, however, thermal electric cooling (hereinafter “TEC”) may be incorporated. A closed loop temperature monitor is included which protects the laser from shortened life due to over-temperature operation.

An electronic feature may be optionally added to monitor and record dazing events tagged with a date and time. Once stored, the event information may be downloaded over an RF link or hard wire connection.

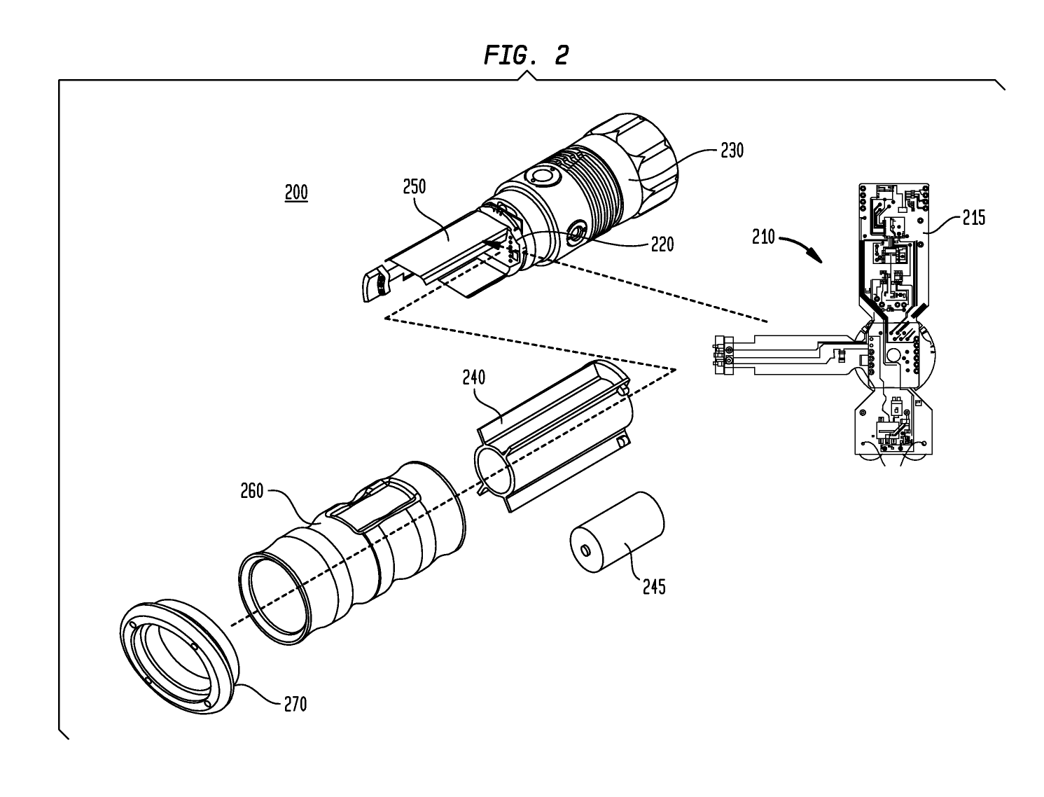

FIG. 2 depicts an exemplary partially-disassembled apparatus. In an embodiment of the invention, the electronics are contained on a flex print together with a stiff center circuit board 210 (hereinafter, “PCB”). The flex print is characterized as having a center hub with at least one wing—3 wings are depicted in FIG. 2. The flex print assembly 210 is mechanically and electrically installed on the front optics/laser assembly 230. The battery frame 260 is then positioned along the centerline of the front optics assembly 230 next to the installed flex print assembly 210.

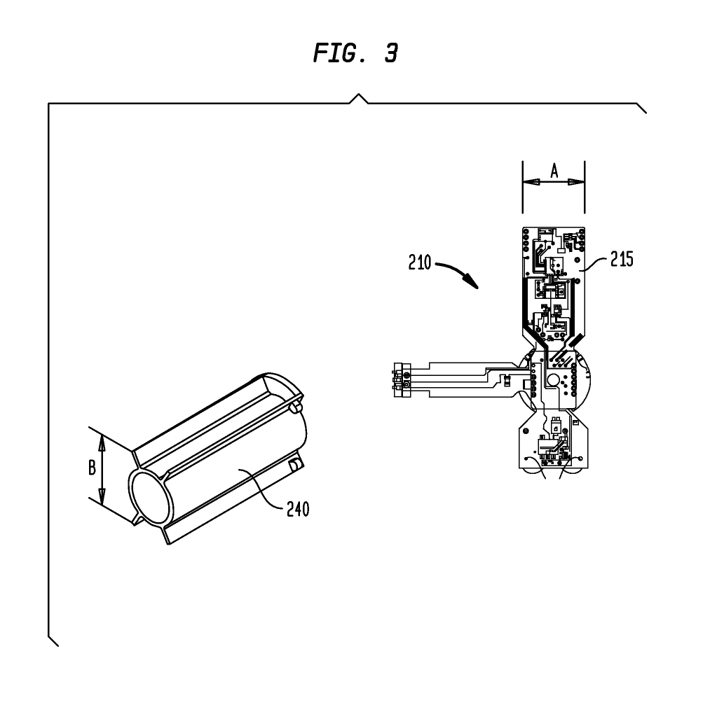

The flex print assembly wings are then folded into and along the battery compartment frame. An important feature of this embodiment of the invention is that the width of the wings 215 of the flex print 210 are designed to be wider than the segment of the battery frame 240 to which they are placed. This is illustrated in FIG. 3, where the dimension A is greater than the dimension B. This apparent interference forces the edges of the wing 215 to curve in order for the wing to be placed within the battery frame segment 245. The resultant bending of the flex print wing edges restrains each flex print wing 215 to fit tightly in the corresponding battery frame segment 245. Casing 260 is then slid over the 210, 240 assembly, and threaded onto the front optics/laser assembly 230. this holds all the inner components and assemblies in proper position circumferentially. The rear cover 270 is then threaded onto the handle 260 to create a rigid apparatus.

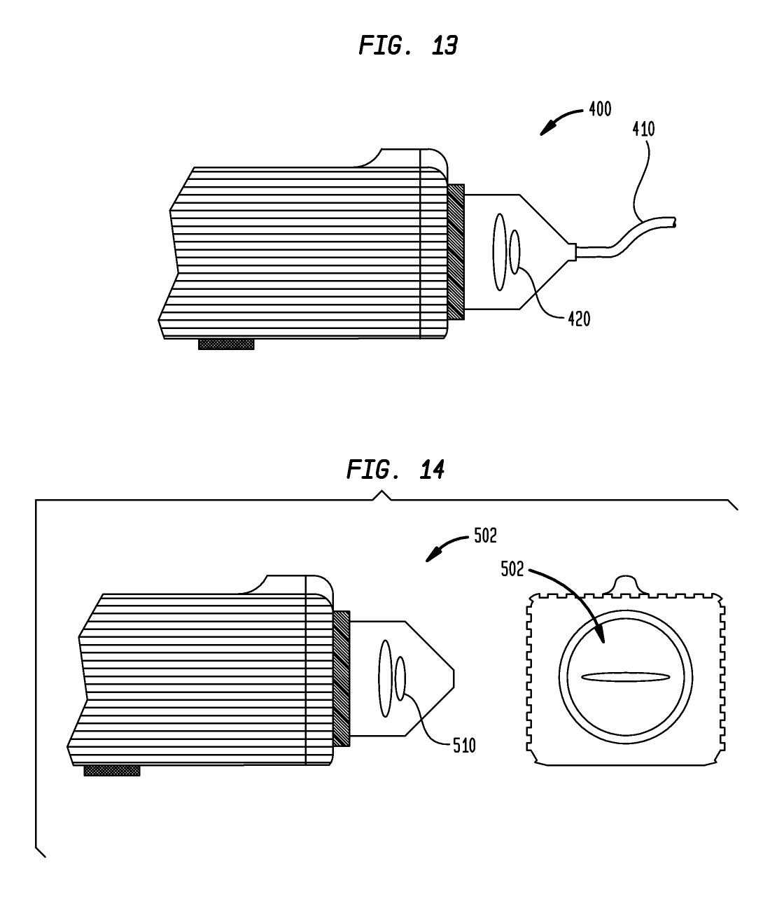

In various embodiments of the invention, control cylinder 101 may be used to attach several accessories, including: as depicted in FIG. 13, a fiber adapter 400 for coupling fiber optics 420 and fiber 410 optic coupler which is used to project the dazing beam, allowing the user to daze around obstacles and under doors; and, as depicted in FIG. 14, a wand-diffuser 502, having wand optics, used to convert the focused beam to a broad asymmetrical beam which disperses the laser energy in a high aspect ratio elliptical shape. The wand-diffuser 502 may use a form of holographic plate or light reflecting facets.

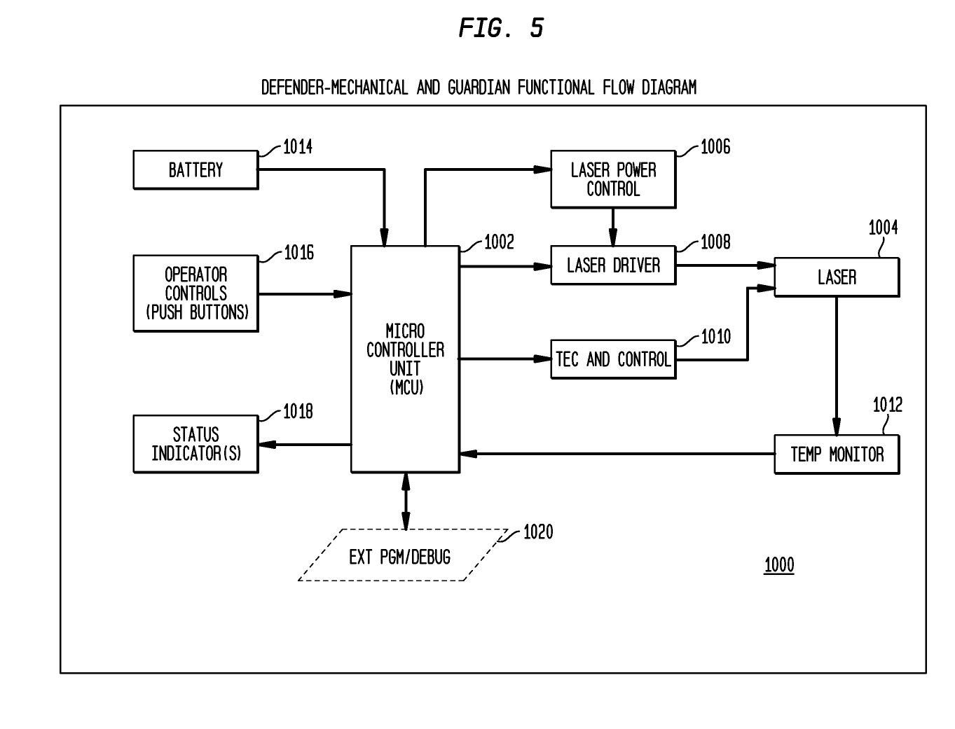

FIG. 5 is a schematic diagram depicting the components of an embodiment of the invention. A micro-controller unit 1002 (hereinafter, “MCU”) provides for the logical operation of the various components of the apparatus. MCU 1002 is a microprocessor together with its associated volatile and non-volatile computer memory (not depicted), that contains the operational program for the apparatus and controls all aspects of the apparatus' operation. The MCU 1002 outputs directly control the laser 1004 by controlling the laser power control circuit 1006, laser driver 1008 and thermo electric cooler (hereinafter, “TEC”) and control 1010. In a preferred embodiment, the MCU 1002 is the PIC18F4520 from Microchip. Those of ordinary skill in computer electronics will understand that the preferred MCU 1002 can be substituted with any suitable processing device or even with multiple processing devices without deviating from the spirit and scope of the invention.

The MCU 1002 also is able to communicate bidirectionally with an external programming and debug apparatus 1020. This apparatus is used to reprogram the MCU 1002, and also to enable monitoring of the MCU 1002 for various purposes, such as for debugging and similar purposes. In normal usage, the external programming and debug apparatus 1020 are not connected to the MCU 1002.

The MCU 1002 also monitors laser 1004 temperature via a temperature monitor 1012. In a preferred embodiment of the invention, a thermistor is used as the temperature monitor 1012. The thermistor forwards a signal to the MCU 1002 that is calibrated in terms of degrees centigrade.

The laser 1004 is a source of radiation of approximately 532 nm, such as a laser diode, and may be of custom design or may be any commercially available 532 nm, 125 mW-500 mW laser. The laser 1004 may be used with reduced range, reduced fluence pattern size, or reduced dazing intensity or any combination of these parameters.

Embodiments of the invention may use any of a variety of lasers depending on the wavelength spectrum of laser desired. In the visible range, the preferred laser is a 808 nm laser diode pumping a ND:YVO4 and KTP crystal combination to produce 532 nm radiation. Other crystal combinations may also be used in the visible band and other wavelength bands may be used, including but not limited to IR and ultraviolet.

The TEC 1010 provides cooling to the laser diode in order to control the laser's 1004 peak temperature. The MCU 1004 controls the TEC 1010 through a power control circuit in a feedback loop using the signal from the temperature monitor 1012. The TEC 1010 is an optional feature of certain embodiments of the invention and is not mandatory.

The MCU 1002 monitors laser temperature and provides TEC, when TEC is included in the instant embodiment of the invention, control, and a fail safe function for the laser 1004 to prevent the laser failing under thermal stress. The MCU 1002 is powered by the battery 1014. The MCU 1002 also takes input from operator controls and push buttons 1016, and outputs to status indicators 1018. The status indicators may take the form of individual LEDs or may be incorporated into an alpha-numeric or graphic display (not depicted).

Battery 1014 provides power to the MCU 1002 as well as to all the other electrical components. Connection of various components with the battery 1014 has been left off the schematic diagrams for clarity.

Laser power control 1006 implements a portion of the MEAN Beam characteristic, described in detail below, by controlling the depth of modulation and peak power levels for the apparatus' dazing and search modes. The laser power control 1006 is implemented essentially as a digital to analog converter, outputting a complex Mean Beam analog voltage signal to the laser driver 1008.

The laser driver 1008 is a current driver that drives the laser 1004 by controlling the amount of current delivered to the laser diode portion of the laser 1004. The laser driver 1008 includes a circuit that converts the complex Mean Beam input analog voltage signal from the laser power control 1006 to an output proportional current. In addition, the laser driver 1008 controls the temporal characteristic of the laser current, e.g., MEAN Beam pulse width modulation, etc., through the digital input signal from the MCU 1002. In a preferred embodiment of the invention, the laser driver 1008 is implemented using the ATLS4A401-D hybrid from Analog Technologies.

The operator controls and push buttons 1016 are available for the user to input the security code, control day and night functionality of the MEAN Beam and force the apparatus into either search or dazing mode—the “dual mode” aspect of the invention. Focus control of the variable range and focus subsystem, which changes divergence of the laser beam in order to focus the beam in a different range as described below, is accomplished by rotating control cylinder 101. Mechanical markings indicating selected ranges may be added to the control cylinder 101 to provide a visual reference of selected focus for the user.

As previously described, the status indicators 1018 may be customized to suite the user, and generally provides feedback to the user on the status of the apparatus. Available status indicators include information regarding the battery, temperature, security mode, focus range, safe range and MEAN Beam night/day setup. A mechanical position reading is optionally provided for target range—the range at which the laser radiation pattern or circle is 1 meter in diameter—and the ANSI safe range—the minimum range for which the laser fluence does not exceed the ANSI fluence level, which means ranges greater than this minimum are completely eye safe for repeated exposures according to the ANSI standard for the safe use of lasers.

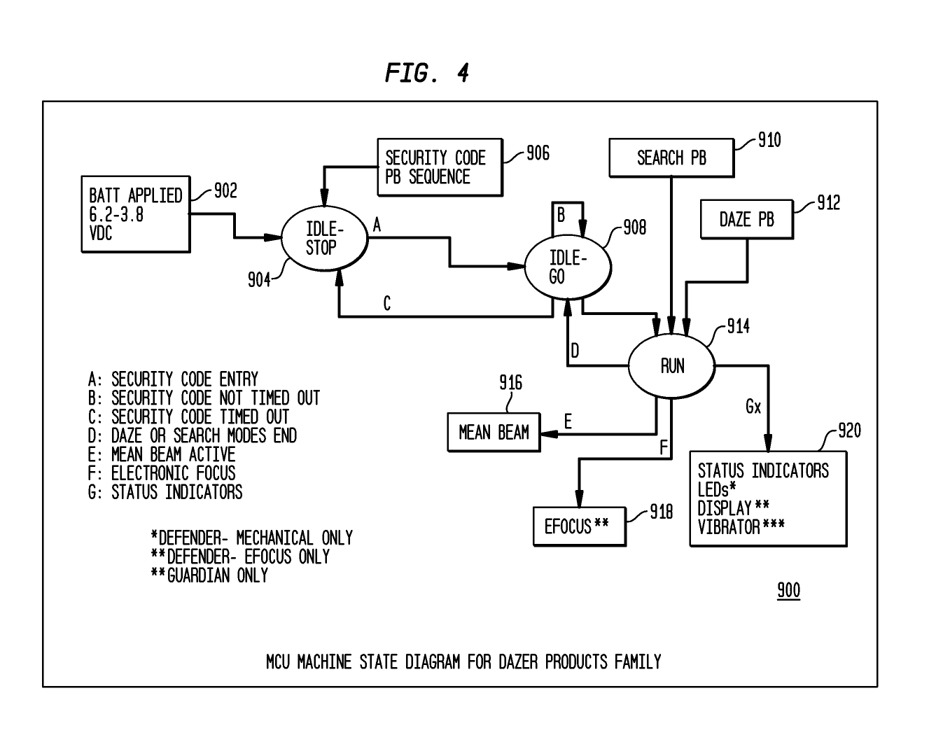

FIG. 4 is a machine state diagram 900 for an MCU 1002 in operation of the present invention. Control of the dazing laser apparatus is provided by the MCU 1002. Upon energy source 902 activation, the MCU 1002 goes through an automatic power on reset sequence (not depicted), and enters an Idle-Stop machine state 904. The Idle-Stop machine state 904 is a low frequency, low drain current sleep state. The MCU 1002 remains in this state with all device functions inhibited until a proper security code is entered.

When the user enters a security code 906, the MCU 1002 checks the entered code against the pre-set correct code. In a preferred embodiment of the invention, the user enters a security code using buttons 109, 110, 111. Also, the pre-set security code is preferably installed in non-volatile memory at the factory. User re-configuration of the security code, and possible use of persistent memory to store the security code are also provided in embodiments of the invention. Other security code implementations are also possible such as, but not limited to a finger print reader, micro bar code, magnetic reader, and by an electronic coded signal using an RF link.

If the entered security code matches the correct code, the MCU 1002 enters a low current drain Idle-Go machine state 908 and provides feedback to the user that the code has been accepted. If the entered security code is rejected, i.e., if it is incorrect, the MCU 1002 returns to the Idle-Stop machine state 904. This security code feature may be expanded to include a lock-out feature after a preset number of inputting incorrect security codes.

While the MCU 1002 is in the Idle-Go machine state 908, all other device functions are enabled and available to the user instantly, with the appropriate push button command. In a preferred embodiment of the invention, current drain in the Idle-Go machine state 908 has been reduced to allow the apparatus to function in this state for approximately ½ year, although improvements in battery capacity and/or reductions in current drain will prolong this amount of time.

Also, while in the Idle-Go machine state 908, a timer begins counting down a security time-out period. The security time-out period is the amount of time the MCU 1002 will remain in the Idle-Go machine state 908 without use before it returns to the Idle-Stop machine state 904 to once again await entry of the security code. The security time-out period is pre-set to a certain time period, for example 24 hours. In one embodiment of the invention, the security time-out period is fixed. In another embodiment, it may be reset by the user. When the security code time-out period is reached and a valid security code has not been re-entered, the MCU 1002 returns to the Idle-Stop machine state 904, which inhibits all functions except re-entry of the security code.

With the MCU 1002 in the Idle-Go machine state 908, the user can select either Dazing mode 912 or Search mode 910. When Dazing mode 912 or Search mode 910 is selected, the MCU 1002 changes from the Idle-Go machine state 908 to the Run machine state 914. Also, the MEAN Beam 916, as well as various status indicators 920 IS then activated.

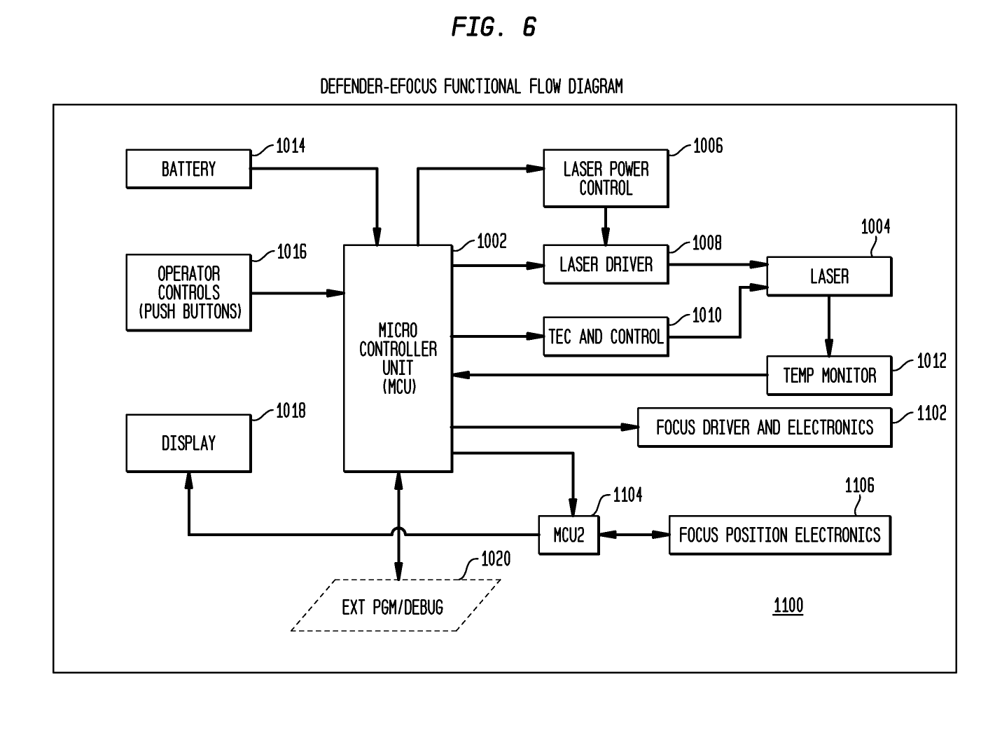

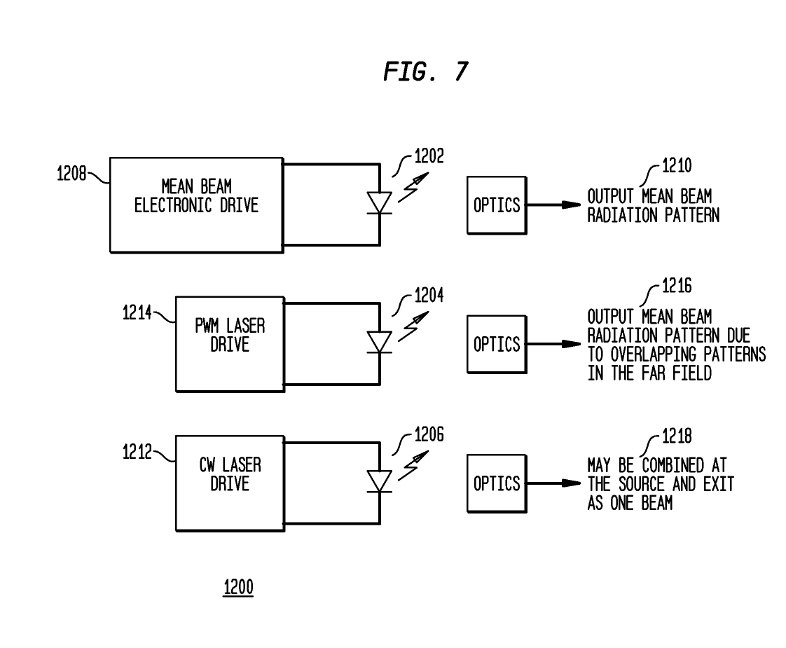

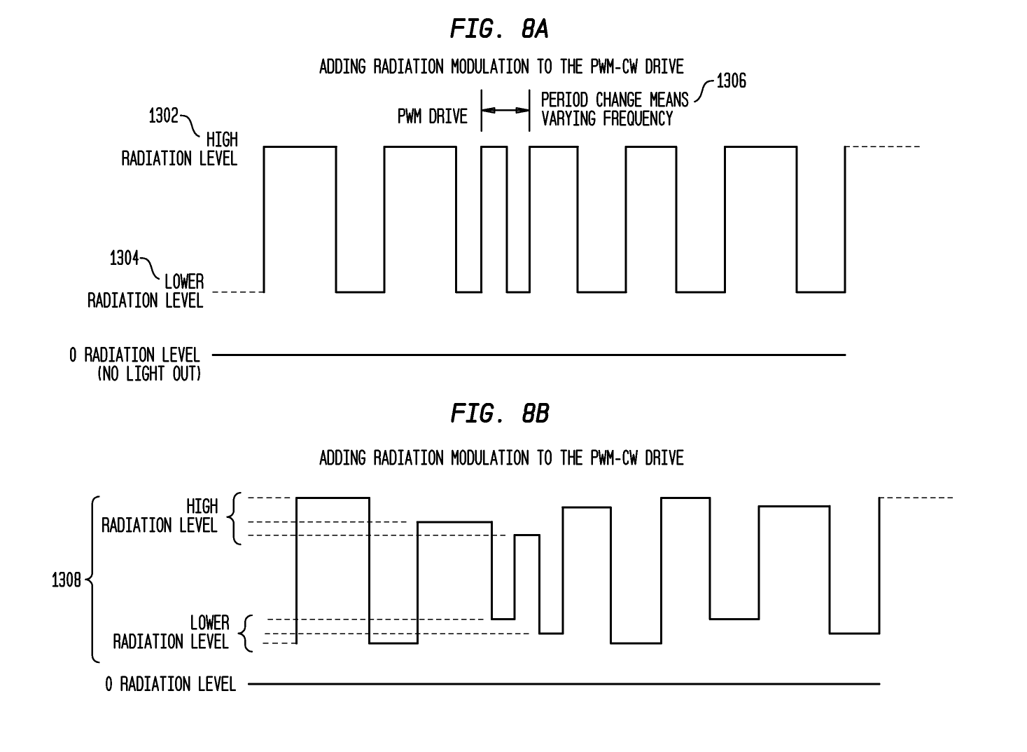

FIG. 6 is a schematic functional diagram 1100 for the EFocus feature of a an embodiment of the invention. The EFocus feature is a term used as shorthand for variable range and focus, which represents a means of dramatically improving the performance of optical dazers or distractors. This feature permits the laser fluence to be both tailored and maximized at any target range. Variable range and focus maximizes dazing effectiveness over a larger device operating range compared to fixed focus optical laser dazer. Other benefits from the present invention's use of variable range and focus include modified engagement tactics and reducing or eliminating collateral warning and dazing, or to enable a wider area of dazing, for example in crowd control.

In order to understand the benefits of a variable range and focus system as it pertains to laser dazing apparatus, a conventional fixed focus system is described first.

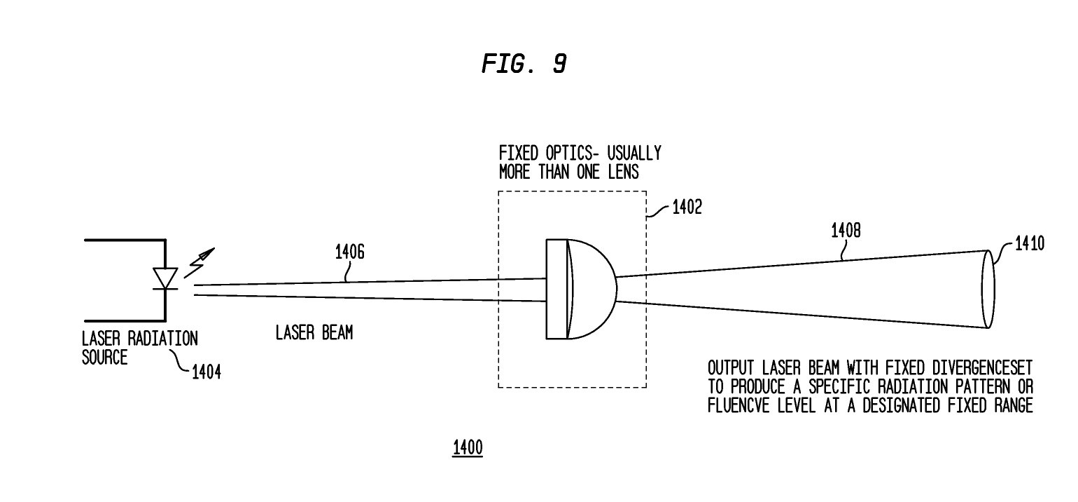

FIG. 9 illustrates a typical fixed focus system 1400 where there is a fixed focus lens assembly 1402 in front of a laser radiation source 1404. The fixed focus lens assembly 1402 is designed to adjust the small divergent laser beam 1406 to a beam having a different divergence 1408, having a specific radiation pattern 1410, also called fluence or fluence level, at a fixed range.

In designing the divergence of the output beam, a designer typically seeks to achieve the longest possible effective dazing range and the shortest possible safe range, which is the shortest range at which the device does not violate the ANSI standard range for safe operation of the laser. Unfortunately, with a fixed focus approach, these two goals cannot be met simultaneously. The designer is forced to compromise between a small divergence which produces unsafe ranges close to the device and a larger divergence to make the device safe close up but which reduces the effectiveness of the device at a longer range. This compromise is illustrated graphically in FIG. 8.

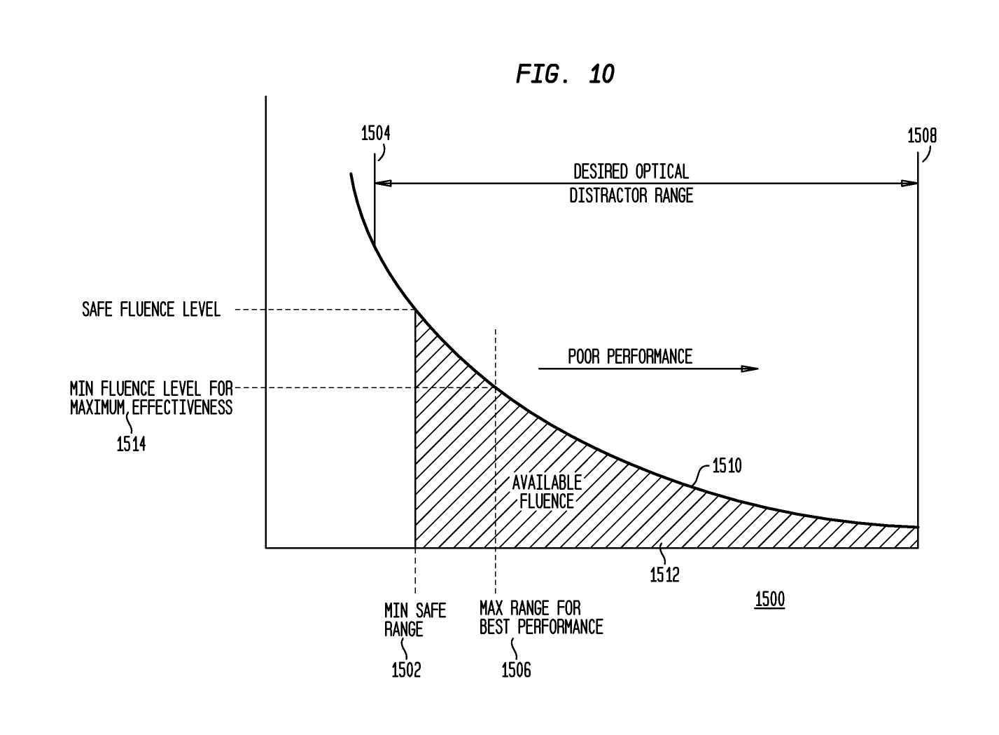

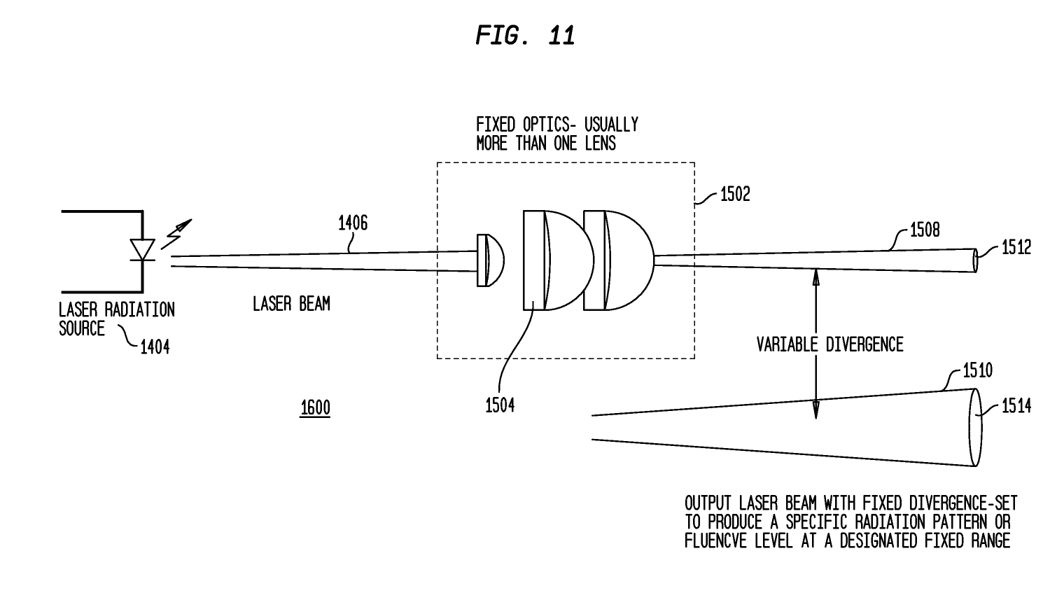

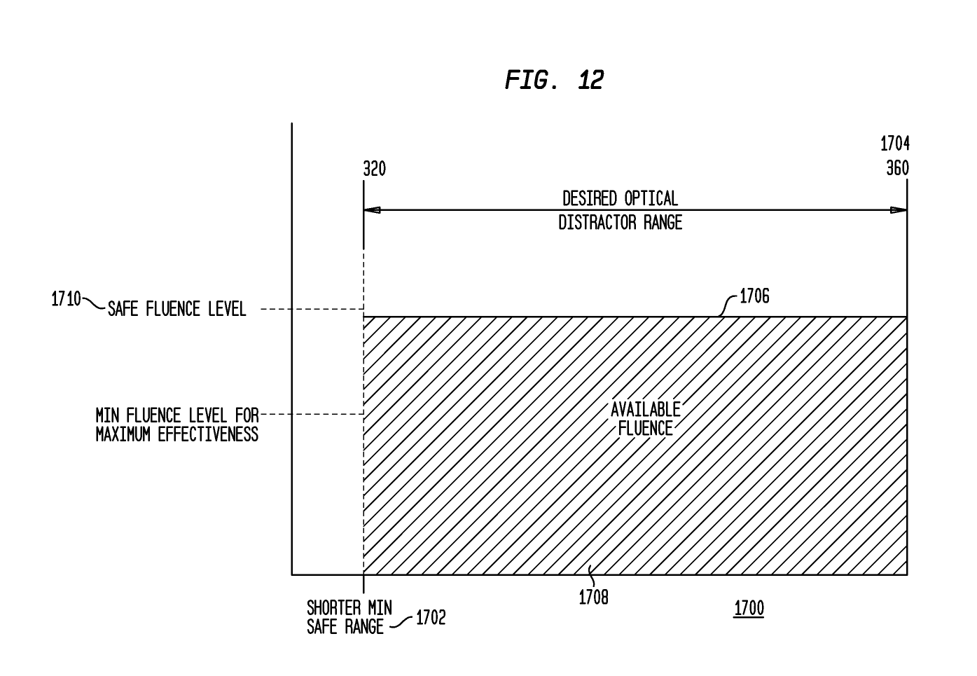

FIG. 10 illustrates 1500 that a compromise has been made at short range to extend the safe range 1502 beyond the shortest range desired 1504 and a significant compromise has been made at longer ranges due to the diminishing fluence level going from the maximum range for best performance 1506 to the desired maximum system range 1508.

This reduction in dazing performance, illustrated by the curve 1510, is the result of the fact that for a fixed focus system where the laser beam divergence is fixed, laser fluence falls off in proportion to the square root of the inverse range. The area 1512 under the curve 1510 reflects this fall-off in fluence as range increases. Reduced dazing effectiveness results from this design compromise at longer range due to the difference between the minimum fluence level 1514 and the resulting fluence level at any particular longer range.

The performance of the laser dazer using the inventive variable range and focus system dramatically improves over lasers using a fixed focus approach. FIG. 9 illustrates an exemplary physical implementation 1600 of the variable range and focus system. Like the fixed focus approach illustrated in FIG. 7, the variable focus optics system 1502 adjusts the laser beam 1406 divergence from a laser radiation source 1404. But this is where the similarity ends. The variable focus optics system 1502 allows the output beam divergence 1508, 1510 to vary between two extremes representing far range 1508 and near range 1510, as well as any range in between (not depicted). In this way the laser dazer's performance can be optimized for any threat encounter range within the system range limits. Corresponding useful and optimized fluence levels 1512, 1514 are thereby produced, respectively.

FIG. 5 is an illustration 1700 depicting typical system performance improvement. By designing a variable focus system into the laser dazer, several system benefits are realized. The following summarizes some of these benefits. First, the design avoids the compromise as described above for the fixed focus approach. Second, the system minimum safe range 1702 is effectively reduced. Third, maximum dazing performance is available at maximum system range 1704. Fourth, Maximum fluence level 1706 is achieved at any range. The strength of the beam or fluence level directly relates to dazing effectiveness, so focusing permits the user to achieve this condition at any range. Fifth, any fluence level less than maximum is allowed to be adjusted at any range 1708—for example, if the user wishes to warn an aggressor and avoid maximum strength dazing as a first step in an encounter, the user simply adjusts the beam spread to a shorter range. As the encounter continues, the user is free to re-adjust focus to a longer range to increase dazing effectiveness. Sixth, the user is able to adjust the fluence level to compensate for different background lighting conditions. Seventh, ANSI safe fluence level 1710 is assured at any range. Eighth, Collateral exposure and dazing is controlled by adjusting the beam size or fluence at a particular range. Ninth, the user is able to quickly transition from warning to dazing without changing position. Tenth, the user is able to perform effective dazing at longer ranges, thereby reducing engagement risks.

The variable range and focus capability may be implemented on a laser dazer as either a manual adjustment or auto-adjustment. A preferred embodiment of the invention provides a manual adjustment feature.

As depicted in FIG. 6, an auto-adjustment implementation of variable range and focus—or EFocus—can be schematically represented as a piggyback onto the system schematic of FIG. 10. In addition to the MCU 1002 and other components described in FIG. 10, an additional MCU 1104 is also provided to interface focus position electronics 1106, MCU 1002, and a display 1108. Additional MCU 1108 interrogates the optic position using an algorithm which converts these position readings to target range and safe range numbers, which are then passed to the display 1108. Additional MCU 1108 also passes on to the display status information on battery, temperature, security code and MEAN Beam night/day setting. A preferred embodiment of the invention uses the PIC18F2520 as additional MCU 1108.

As an alternative to the manual focus adjustment, an optional focus driver and electronics 1102 provides an electro-mechanical subsystem for changing the position of movable optical components for the purpose of changing the divergence of the laser beam, which effectively changes the target and safe ranges. Micro motors based on the piezo-electric principle and Hall effect sensors may be used in an embodiment of the invention to move the optical components.

Focus position electronics 1106 is an electrical subsystem that monitors and reports position of the movable optical components.

The laser beam produced in a preferred embodiment of the invention is referred to herein as a “MEAN” Beam, which is an acronym for “Modulated, Erradically pulsed, Awareness inhibiting, and Nausea inducing.”

A MEAN Beam is an inventive approach for generating a radiation waveform from any light emitting device, such as but not limited to a laser diode or LED. This approach combines a pulse width modulated (hereinafter, “PWM”) beam with a continuous wave (hereinafter, “CW”) beam in such a way as to produce a waveform that varies both temporally and spatially in one or more radiation sources. Additionally, the PWM and CW are made to vary in different ways depending on ambient light conditions. It has been discovered that this type of MEAN Beam waveform enhances the temporary debilitating effect that a radiation beam has on a person's vision and brain, such as experienced in devices specifically designed for this purpose, such as a laser dazer, also known by the military term as “optical distractors.”

Note also that an embodiment of the present invention provides for using an LED laser source for search mode and a laser diode for dazing mode.

The fundamental characteristic of a MEAN Beam is the combination of a PWM beam with a CW beam in several different ways as illustrated 1200 in FIG. 7. As illustrated, this may be done by electronically driving one radiation source 1202 with a complex signal 1208 to produce one radiation pattern 1210 which varies both in time and space, or, alternatively, to produce different radiation pattern in two sources 1204, 1206, where each varies only in space 1212 or time 1214, then spatially 1216 or optically 1218 combine the radiation patterns or beams to produce a beam with the MEAN Beam functional characteristic. These basic techniques of applying a single complex drive to one radiation source or separate PWM and CW drives to two radiation sources may be extended to multiple radiation sources in both cases. Although FIG. 4 represents the MEAN Beam laser source as a laser diode, the concept is not limited to this type of source—any other laser source may also be employed.

The MEAN Beam concept also encompasses various other radiation patterns operating sequentially from one or several radiation sources. For example, a MEAN Beam followed by an interval of pure PWM, followed by an interval of pure CW may be used. The following detailed description of a MEAN Beam assumes a single laser diode radiation source, or simply laser, since this is the more complex implementation of the MEAN Beam concept.

FIGS. 8A and 8B illustrate MEAN Beam functional characteristics. A MEAN Beam laser operates in neither a constant-on nor a pulsed on and off mode, but rather in an in-between mode where the on portion is characterized by PWM at a high radiation level 1302 and the PWM off half period is characterized by a lower level 1304 of radiation which is not zero. This lower level 1304, occurring during the PWM off interval, as well as the higher level 1302, occurring during the PWM on interval, may be fixed or vary over time. In addition, the PWM frequency may be fixed or may vary over time 1306.

Combining PWM and CW in one laser diode is accomplished by driving the laser to a defined high power level, and then to a defined lower power level, as shown in FIG. 8A. The high 1302 and low 1304 radiation levels may be fixed or may vary over time using any of a number of radiation level modulation schemes. FIG. 8A illustrates the basic concept without radiation level modulation, whereas FIG. 8B illustrates the concept with radiation modulation 1308.

The PWM frequencies 1306 together with the CW modulation 1308 scheme used in an embodiment of the MEAN Beam in the present invention are particularly chosen to enhance the temporary debilitating effect that a radiation beam has on a person's vision and brain in a laser dazer device. This effect may be further enhanced by tailoring the MEAN Beam characteristics as a function of the ambient light conditions. For example, the PWM frequency may be a range of frequencies between F1 Hz and F2 Hz, and the instantaneous frequency may be caused to slew between F1 and F2. While the PWM changes, the CW modulation depth 1308 may be changed to a preferred depth for night operation and to a different depth for day operation. In addition, the two frequency extremes F1 and F2, as well as the slew rate, or time to transition from F1 to F2 and back, may be changed to coincide with day and night operations, or for other physiological reasons. This change in MEAN Beam characteristics based on prevailing light conditions may be automatic or may be by manual adjustment directed by the device user.

The principle of adjusting MEAN Beam operating characteristics based on light conditions may be extended to other physical conditions such as, but not limited to rain, snow and humidity.

The principle of adjusting MEAN Beam operating characteristics based on physical conditions may also be extended to tailoring the parameters to be most effective against a person's eye-brain physiology.

A preferred embodiment of the invention uses a laser with a wavelength in the visible spectrum, having a wavelength from 400-700 nm, most preferably “green” with a wavelength of approximately 532 nm. The daytime preferred MEAN Beam is 10-30% PWM, most preferably 20% PWM, with the remainder CW, and 5-20 Hz PWM, most preferable 6-15 Hz PWM. The nighttime preferred MEAN Beam is 30-70% CW, most preferably 60% CW, with the remainder PWM, and 5-20 Hz PWM, most preferable 6-15 Hz PWM.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A laser dazing apparatus comprising:
an elongated cylindrical encasement having a forward end and a rear end, the encasement further comprising a control cylinder (101) at the forward end housing a focusing range adjustment fixture and a laser aperture (107), the encasement further comprising a finned heat sink (106), a set of circumferential finger detents(102), a plurality of indicators (109), operating buttons (110) and switches (112), and a rear push button trigger (104);
the cylindrical encasement provides an enclosure for a laser generator (220), a least one battery (245) for electrical power, and a plurality of control circuits (210, 215) in communication with the laser generator (220), battery (245), indicators (109), buttons (110) and switches (112);
wherein said laser generator comprises a single radiation source to generate both a pulse width modulated (PWM) and continuous wave (CW) laser beam, and the switches (111) comprise at least one switch (111) for selecting between the laser generator generating a PWM and a CW laser beam, or both;
the push button trigger (104) is in communication with the control circuits;
wherein, in use, the trigger (104) causes the control circuits to control the laser generator to generate electromagnetic output.

2. (canceled)

3. The laser dazing apparatus according to claim 1, wherein the switch (111) for selecting between the PWM and CW modes further provides for selection of an intermediate mixture of PWM and CW modes.

4. The laser dazing apparatus according to claim 3, wherein the switch (111) for selecting between the PWM and CW modes further provides for selection of a radiation modulation mode in which output radiation varies in time and intensity between one or more high levels and one or more low levels.

5. The laser dazing apparatus according to claim 4, wherein the at least one battery (245) is rechargeable.

6. The laser dazing apparatus according to claim 4, wherein the at least one battery (245) is non-rechargeable.

7. The laser dazing apparatus according to claim 4, wherein the laser generating device (220) comprises more than one laser diode.

8. The laser dazing apparatus according to claim 7, wherein the wavelength of radiation output by each laser diode varies.

9. The laser dazing apparatus according to claim 8, wherein the switches (110) further comprises a switch for toggling between a laser search mode and a dazing mode.

10. The laser dazing apparatus according to claim 9, wherein the amplitude and PWM of each laser diode in dazing mode may be the same or different, and may be time variable.

11. The laser dazing apparatus according to claim 10, further comprising a switch (109) for enabling an instant dazing mode, and a switch for activating dazing, wherein during use of the apparatus, selection of instant dazing mode enables the dazing mode activation switch to immediately activate dazing.

12. The laser dazing apparatus according to claim 11, wherein the focusing fixture provides for the output radiation to be continuously focused from 1 meter to 2400 meters with a preferred radiation fluence size.

13. The laser dazing apparatus according to claim 12, further comprising an optical fiber attachment (400) which, when affixed to the forward end of the apparatus, allows the device to be used around corners.

14. The laser dazing apparatus according to claim 13, wherein the optical fiber attachment (400) is affixed to the focusing range adjustment fixture.

15. The laser dazing apparatus according to claim 12, whereby, in operation, the apparatus enters a sleep mode after a predetermined period of time without use, and the device will not further operate until the plurality operating buttons (109, 110, 111) are pressed in a predetermined sequence.
